(19) United States
(12) Patent Application Publication
(10) Pub. No.: US 2026/0102796 A1
(43) Pub. Date: Apr. 16, 2026

(54) Plasma Treatment With Liquid Cooling

(71) Applicant: Plasmatreat GmbH, Steinhagen (DE)

(72) Inventors: Daisuke Nishiyama, Suita-shi, Osaka (JP); Dhia Ben Salem, Paris (FR); Magnus Buske, Steinhagen (DE); Christian Buske, Bielefeld (DE)

(21) Appl. No.: 19/116,495

(22) PCT Filed: Sep. 26, 2023
(86) PCT No.: PCT/EP2023/076530

§ 371 Date: Mar. 28, 2025

(30) Foreign Application Priority Data
Sep. 29, 2022 (DE) 10 2022 125 118.7
Mar. 16, 2023 (DE) 10 2023 106 618.8

(51) Int. Cl. B08B 7/00; C23G 5/00; H05H 1/32

(52) U.S. Cl. CPC B08B 7/0035; C23G 5/00; H05H 1/32; H05H 2242/10; H05H 2245/40

(57) ABSTRACT

A method for the treatment, in particular for cleaning, reduction treatment and/or coating, of a workpiece, in which an atmospheric plasma jet is generated. A workpiece to be treated, in particular a workpiece to be cleaned, reduced and/or coated, is brought into contact with a liquid. A surface of the workpiece to be treated or the liquid is impinged with the atmospheric plasma jet. An apparatus for the treatment, in particular for cleaning, reduction treatment and/or coating, of a strip-shaped workpiece, in particular a metal strip, in particular for carrying out the afore-mentioned method.

### CROSS-REFERENCE TO RELATED APPLICATIONS

This application is the United States national phase of International Patent Application No. PCT/EP2023/076530, filed Sep. 26, 2023, and claims priority to German Patent Application Nos. 10 2022 125 118.7, filed Sep. 29, 2022, and 10 2023 106 618.8, filed Mar. 16, 2023, the disclosures of which are hereby incorporated by reference in their entireties.

### BACKGROUND OF THE INVENTION

### Field of the Invention

The present invention relates to a method for the treatment of a workpiece, in particular for cleaning, reduction treatment and/or coating of a workpiece, and to an apparatus for the treatment, in particular cleaning, reduction treatment and/or coating, of a strip-shaped workpiece.

Methods for the reduction treatment of workpieces are carried out, for example, in order to achieve better thermal and/or electrical contactability or better wettability of the workpiece surfaces, for example with solder. The reduction treatment of workpieces is often aimed at facilitating subsequent process steps on the workpieces, such as bonding or soldering with other workpieces, or making them possible in the first place.

### Description of Related Art

Various methods for reduction treatment are known from the state of the art. Some of these methods use, for example, chemical reducing agents such as fluxes. However, these are typically corrosive and harmful to health or release harmful vapors. Reduction methods using low-pressure plasmas are also known, for example from WO 00/29642 A1. However, such low-pressure methods have the disadvantage that they can only be integrated into a continuous production operation with a great deal of technical effort due to the necessary feed and discharge processes. In addition, selective reduction treatments, in which only certain parts of a workpiece surface are to be reduced, are difficult to implement with such low-pressure methods.

Consideration has also been given to using atmospheric plasma methods for reduction treatment. However, it was found that these methods often lead to rapid reoxidation of the reduced workpiece surface, so that the workpiece surfaces in question were ultimately not reliably freed from oxides.

Furthermore, various methods for coating workpieces using an atmospheric plasma jet are known from the prior art, for example from EP 1 230 414 B1, and there is a need to further improve coating methods using an atmospheric plasma jet.

Furthermore, various methods for cleaning workpieces are known from the state of the art, in particular for subsequent coating, and there is a need to carry out such a cleaning method efficiently.

### SUMMARY OF THE INVENTION

Against this background, the present invention is based on the object of providing an improved method and an improved apparatus for the reliable treatment, in particular cleaning, reduction treatment and/or coating, of workpieces, which are particularly suitable for inline use and preferably enable selective treatment, in particular cleaning, reduction treatment and/or coating, of workpiece surfaces.

According to the invention, this object is solved by a method for the treatment of a workpiece, in which an atmospheric plasma jet is generated, in which a workpiece to be treated is brought into contact with a liquid and in which a surface of the workpiece to be treated, in particular of the workpiece to be cleaned, reduced and/or coated, and/or the liquid is impinged with the atmospheric plasma jet.

According to the invention, the aforementioned object is solved in particular by a method for the reduction treatment of a workpiece, in which an atmospheric plasma jet is generated, in which a workpiece to be reduced is brought into contact with a liquid and in which a surface of the workpiece to be reduced and/or the liquid is impinged with the atmospheric plasma jet. It has been found that a surface of a workpiece can be reliably reduced in this way.

Reduction treatment of a workpiece surface means in particular that oxides on the workpiece surface are chemically converted so that after the reduction treatment there are no or at least fewer oxidic components on the then reduced workpiece surface or the reduced workpiece surface section. The oxides on the workpiece surface can be reduced in particular by removing oxygen from the oxides and chemically binding the oxygen in some other way, for example by using species contained in the plasma jet. A reduction treatment, for example of the surface of a copper workpiece, can convert, e.g., copper oxides present on the surface into copper by removing the oxygen.

In the context of the present invention, it was found that in previous tests of reduction treatments on workpiece surfaces with an atmospheric plasma jet, it was primarily the heating of the workpiece by the plasma jet that led to increased reoxidation of the workpiece surface. By bringing the workpiece into contact with a liquid, the method described here can achieve that the workpiece is cooled in the area of the surface to be reduced, so that this area is less prone to reoxidation after the reduction treatment. Furthermore, the workpiece surface can, by the contact with the liquid, be at least partially covered with the liquid, whereby direct contact of the workpiece surface with an oxygen-containing atmosphere in the environment is prevented or at least reduced, so that reoxidation is also prevented or reduced in this way.

For the reduction treatment, an atmospheric plasma jet is generated and a surface of the workpiece to be reduced and/or the liquid is impinged with the atmospheric plasma jet. The actual reduction of oxides on the workpiece surface can therefore be achieved in particular by impinging a surface of the workpiece, in particular a section of the workpiece surface to be reduced, with the atmospheric plasma jet. Additionally or alternatively, the reduction of oxides on the workpiece surface can also be carried out in such a way that, instead of direct impinging of the workpiece with the atmospheric plasma jet, the liquid is impinged with the atmospheric plasma jet, whereby it is plasma-activated. It has been found that a liquid plasma-activated in this way can also have a reducing effect on the surface of the workpiece. In this embodiment, particularly effective cooling and contact reduction with an oxygen-containing atmosphere is achieved by the liquid.

It was also found that impinging the liquid with the atmospheric plasma jet increases the effective range of the reduction treatment beyond the width of the plasma jet, since the liquid impinged with the plasma jet also causes a reduction treatment on the workpiece surface outside the immediate area of influence of the plasma jet. In contrast to a dry reduction treatment using a plasma jet, in which a workpiece surface is only subjected to a reduction treatment in the area impinged with the plasma jet, a larger workpiece surface area can thus be subjected to a reduction treatment using a plasma jet with the present method, so that, for example, a larger workpiece can be subjected to a plasma reduction treatment with a smaller number of plasma nozzles or with a smaller number of transitions.

The reducing effect of the atmospheric plasma jet can be achieved by generating the atmospheric plasma jet with a reducing gas or gas mixture, for example forming gas. Additionally or alternatively, it is possible that a reducing agent is added to the atmospheric plasma jet or brought into contact with the surface of the workpiece to be reduced in some other way, for example with the liquid.

In particular, the method is used for the reduction treatment of at least partially metallic workpiece surfaces of a workpiece that is at least partially made of metal, for example a metal alloy. The metal may be copper, for example.

In particular, the workpiece may be a strip-shaped workpiece, especially a metal strip. The reduction treatment of strip-shaped workpieces can be carried out, for example, to prepare the workpiece surface for subsequent coating, in particular coil coating.

According to the invention, the aforementioned object is further solved in particular by a method for coating a workpiece, in which an atmospheric plasma jet is generated, in which a workpiece to be coated is brought into contact with a liquid and in which a surface of the workpiece to be coated and/or the liquid is impinged with the atmospheric plasma jet. It was found that a surface of a workpiece can be coated reliably and evenly in this way.

In particular, the workpiece may be coated with a metal layer with the method.

For the coating, a precursor, preferably a salt, is added to the liquid, in particular a salt is dissolved in the liquid. It has been found that a workpiece surface can be effectively coated in this way, with the precursor or a reaction product of a reaction of the precursor forming the coating. The atmospheric plasma jet or reactive species generated in the liquid by the atmospheric plasma jet, such as OH⁻, can in particular cause a chemical redox reaction in which the precursor or a component thereof, in particular a dissociated component of a salt dissolved in the liquid as a precursor, is reduced by electron acceptance and forms a coating on the surface of the workpiece. The dissociated component may in particular be an ionic residue of a salt, in particular a cationic residue, in particular a metal ionic residue of a salt.

If, for example, a metal salt, such as a copper salt, is used as a precursor, the metal cation of the metal salt, such as Cu²⁺, can be reduced to the elemental metal, such as Cu, by interaction with the atmospheric plasma jet or with the liquid impinged with the atmospheric plasma jet, so that elemental metal, such as Cu, is deposited on the surface of the workpiece to be coated and a metal coating, such as a copper coating, is formed in this way.

In the method described here for coating a workpiece, a reduction refers in particular to the acceptance of one or more electrodes. Oxygen can be involved in the chemical redox reaction, but this is not necessary.

By bringing the workpiece into contact with a liquid, a uniform coating can be achieved in the method for coating a workpiece, in particular by the precursor or by a reaction product of a reaction of the precursor. Furthermore, the workpiece can be cooled in this way in the area of the surface to be coated and/or protected from direct contact with an oxygen-containing atmosphere in the environment, whereby a reversal of a redox reaction caused by the plasma jet or oxidation of the reduced components or the workpiece surface can be counteracted.

For the coating, an atmospheric plasma jet is generated and a surface of the workpiece to be coated and/or the liquid is impinged with the atmospheric plasma jet. The actual coating of the workpiece surface can thus be accomplished in particular by impinging a surface of the workpiece, in particular a section of the workpiece surface to be coated, with the atmospheric plasma jet, wherein the coating material is provided from the liquid, in particular by the precursor or a reaction product of a reaction of the precursor. Additionally or alternatively, the coating of the workpiece surface can also be carried out in such a way that instead of a direct impinging of the workpiece with the atmospheric plasma jet, the liquid is impinged with the atmospheric plasma jet, whereby it is plasma-activated. It has been found that a liquid plasma-activated in this way can cause a redox reaction on a precursor dissolved in the liquid or a component thereof, in particular on a dissociated component of a salt dissolved in the liquid as a precursor, due to the reactive species contained therein, such as OH⁻, so that a coating of the surface of the workpiece occurs. In this embodiment, particularly effective cooling and contact reduction with an oxygen-containing atmosphere is also achieved by the liquid.

It was also recognized that impinging the liquid with the atmospheric plasma jet increases the effective range of the coating beyond the width of the plasma jet, since the liquid impinged with the plasma jet also causes a coating on the workpiece surface outside the immediate area of influence of the plasma jet. In contrast to dry coating by means of a plasma jet, in which a workpiece surface is coated only in the area impinged with the plasma jet, a larger workpiece surface area can thus be coated with a plasma jet using the method, so that, for example, a larger workpiece can be coated with a smaller number of plasma nozzles or with a smaller number of transitions.

The atmospheric plasma jet can be generated with nitrogen (N₂), argon, air, forming gas (nitrogen-hydrogen mixture) or an argon-hydrogen mixture, for example.

The plasma jet itself already has a certain reducing effect, even if it is generated with a generally non-reducing gas such as nitrogen, so that the plasma jet can, for example, cause a redox reaction on a salt dissolved as a precursor in the liquid or a dissociated component of the salt.

In order for the atmospheric plasma jet to cause or intensify a redox reaction on a precursor in the liquid, in particular on a salt dissolved as a precursor in the liquid or a dissociated component of the salt, the atmospheric plasma jet is preferably generated with a reducing gas or gas mixture, for example forming gas or an argon-hydrogen mixture. Additionally or alternatively, it is possible that a reducing agent is added to the atmospheric plasma jet or brought into contact with the surface of the workpiece to be coated and/or the liquid in some other way. For example, if the plasma jet is generated with air, nitrogen or argon, a hydrogen-containing agent can be added to the plasma jet or the liquid or a hydrogen-containing liquid can be used to provide hydrogen for the redox reaction. In this way, a stronger coating effect can be achieved.

The workpiece to be coated may, for example, be a workpiece made of polymer, glass, metal, wood, ceramic, leather or textile material, such as fabric. The workpiece to be coated can also consist of different materials, whereby the workpiece in the area of the surface to be coated preferably consists of one or more of the following materials: polymer, glass, metal, wood, ceramic, leather or textile material.

The workpiece to be coated may also be a strip-shaped workpiece, in particular a metal strip.

According to the invention, the aforementioned object is furthermore solved in particular by a method for cleaning a workpiece, in which an atmospheric plasma jet is generated, in which a workpiece to be cleaned is brought into contact with a liquid and in which a surface of the workpiece to be cleaned and/or the liquid is impinged with the atmospheric plasma jet. It has been found that a surface of a workpiece can be cleaned reliably and evenly in this way. The workpiece to be cleaned may also be a strip-shaped workpiece, in particular a metal strip.

The aforementioned object is further solved according to the invention by an apparatus for the treatment, in particular for cleaning, reduction treatment and/or coating, of a strip-shaped workpiece, in particular a metal strip, in particular for carrying out the method described above for treating a workpiece, in particular the method described above for reduction treatment or the method described above for coating or the method described above for cleaning or a respective embodiment thereof, with an immersion bath device which is configured to guide a strip-shaped workpiece through an immersion bath and with a plasma source for generating an atmospheric plasma jet, wherein the plasma source is arranged and configured to impinge, during operation, the immersion bath or to a strip-shaped workpiece guided through the immersion bath of the immersion bath device with an atmospheric plasma jet. With such an apparatus, strip-shaped workpieces, in particular metal strips, can be treated effectively and reliably, in particular subjected to a reduction treatment and/or coated and/or cleaned. Furthermore, such an apparatus can be easily integrated inline into a continuous production operation.

In particular, the plasma nozzle may be arranged and configured to impinge, during operation, a strip-shaped workpiece guided through the immersion bath device with the atmospheric plasma jet. In this way, the treatment, in particular cleaning and/or reduction treatment and/or coating, can be achieved by directly impinging the workpiece with the plasma jet. Furthermore, the plasma nozzle may also be arranged and configured to impinge, during operation, the immersion bath with the atmospheric plasma jet. As previously described in relation to the method, it has been found that the treatment effect, in particular the cleaning effect and/or reducing effect and/or coating, can also be achieved by impinging the liquid brought into contact with the strip-shaped workpiece with the atmospheric plasma jet, so that direct impinging of the workpiece with the plasma jet is not necessarily required.

In addition, impinging the liquid of the immersion bath with the plasma jet has the advantage that the treatment effect, in particular the reduction effect and/or coating and/or cleaning effect, is increased beyond the width of the plasma jet, so that wider surface strips on the workpiece surface can be subjected to treatment with one plasma nozzle, in particular reduction treatment and/or coating and/or cleaning, and, for example, the number of plasma nozzles required for the treatment, in particular reduction treatment and/or coating and/or cleaning, of a strip-shaped workpiece per predetermined width can be reduced, in particular compared to a dry plasma treatment method, in particular a dry plasma reduction method or a dry plasma coating method or a dry plasma treatment method.

In particular, the immersion bath device may have a container for holding a volume of liquid that forms an immersion bath and guide means that are arranged and configured to guide a strip-shaped workpiece through the immersion bath. Suitable guide means include, for example, guide rollers, which can also be easily integrated into a continuous production operation.

The apparatus may have dispensing and receiving means which are configured for dispensing the strip-shaped material before the treatment, in particular reduction treatment and/or coating and/or cleaning, and for receiving the strip-shaped material after the treatment, in particular reduction treatment and/or coating and/or cleaning. The dispensing and/or receiving means may, for example, be designed as roll(s), so that the strip-shaped material can be unrolled from the dispensing means for dispensing or rolled onto the receiving means for receiving. This embodiment enables compact storage of the material and reduces the contact between its surface and the oxygen-containing atmosphere in an advantageous manner, so that the oxidative effect of the atmospheric air on the surface of the strip-shaped workpiece is reduced.

Furthermore, the apparatus may have transport means for transporting the strip-shaped workpiece through the immersion bath device. These transport means may be formed by the guide means, for example by rotating rollers, and/or by the dispensing and receiving means, for example by driven dispensing and/or receiving means. Alternatively or additionally, separate transport means may be provided.

Furthermore, the apparatus may have sensors for measuring the temperature of the liquid and/or the workpiece, which makes it possible to monitor and/or control the operation. In particular, the temperature of the workpiece can be controlled in this way, for example when it emerges from the immersion bath, so that heating of the strip-shaped workpiece above a predetermined temperature value is prevented in the immersion bath, for example by cooling it with preferably provided coolants, in order to prevent reoxidation processes or oxidation processes in general after it emerges from the immersion bath. If the temperature of the workpiece and/or the immersion bath increases too much, for example, the cooling capacity of the coolants provided can be increased, the transport speed of the workpiece through the immersion bath and/or the intensity of the plasma jet can be regulated.

Furthermore, the apparatus may have several plasma sources. For the treatment, in particular reduction treatment and/or coating and/or cleaning, of large surfaces, for example wide strip-shaped workpieces or several strip-shaped workpieces arranged next to one another, the plasma sources may be arranged in particular transversely to the transport direction of the strip-shaped workpiece. Additionally or alternatively, several plasma sources can also be provided along the transport direction of the strip-shaped workpiece in order to enable particularly rapid guidance of the strip-shaped workpiece with sufficient treatment effect, in particular sufficient reducing treatment effect and/or sufficient coating and/or sufficient cleaning.

Various embodiments of the methods and the apparatus are described below, the individual embodiments applying in each case independently of one another to the method for treatment, in particular to the method for reduction treatment, to the method for coating and to the method for cleaning, and to the apparatus for treatment, in particular reduction treatment and/or coating and/or cleaning. Furthermore, the individual embodiments can be combined with one another as desired.

In one embodiment of the method for the treatment, in particular reduction treatment and/or coating and/or cleaning, the workpiece is brought into contact with the liquid by arranging the workpiece in a volume of liquid, in particular by submerging it, before the surface or the liquid is impinged with the plasma jet. In this way, the contact between the liquid and the workpiece is increased, so that better cooling of the workpiece is achieved by the liquid, especially in the area of the workpiece surface to be treated, in particular to be reduced and/or coated and/or cleaned. Furthermore, the contact of the workpiece surface with an atmosphere that may contain oxygen can be reduced in this way. In this way, oxidation or re-oxidation of the treated, in particular reduced and/or coated and/or cleaned, workpiece surface can be prevented or at least reduced. Preferably, the workpiece is arranged in the liquid volume in such a way that the height of coverage of the liquid volume over a surface of the workpiece directed towards the surface of the liquid volume, in particular the surface of the workpiece to be treated, in particular to be reduced and/or coated and/or cleaned, is at least 1 mm, preferably at least 3 mm, particularly preferably at least 5 mm.

In a further embodiment of the method for treatment, in particular reduction treatment and/or coating and/or cleaning, the impinging with the atmospheric plasma jet is accomplished in such a way that a portion of the liquid volume located above the workpiece is locally displaced by the atmospheric plasma jet. In this way, an effective impinging of the surface of the workpiece to be treated, in particular to be reduced and/or coated and/or cleaned, with the atmospheric plasma jet can be achieved even if the workpiece is arranged in the liquid, in particular if it is submerged in it. By locally displacing the liquid with the plasma jet, a stronger reduction effect and/or more targeted coating and/or cleaning can be achieved.

The atmospheric plasma jet may locally displace the liquid volume above the workpiece in particular practically completely, so that no liquid or only a thin liquid film with a height above the workpiece surface of less than 1 mm, in particular less than 10 μm, for example in the size range of a few molecular layers, remains locally at the point of plasma impact. In this way, practically direct impinging of the workpiece with the plasma jet can be achieved, resulting in a particularly strong and targeted treatment, in particular reduction effect and/or coating and/or cleaning.

As the liquid is displaced locally, the workpiece remains sufficiently covered with liquid outside the plasma jet and can therefore be effectively cooled and/or shielded from an oxygen-containing atmosphere.

Alternatively, the atmospheric plasma jet may also displace the liquid volume above the workpiece in such a way that a macroscopic liquid volume, for example with a height of at least 1 mm, preferably at least 2 mm, more preferably at least 3 mm, remains above the workpiece surface at the point of plasma impact. In this way, a good and targeted treatment effect, in particular reduction effect and/or coating and/or cleaning, can also be achieved. At the same time, the liquid is continuously covered by the liquid during plasma application, so that more efficient cooling of the workpiece surface is achieved and direct contact with oxygen in the surrounding atmosphere is prevented.

The displacement of the liquid volume, in particular the degree of displacement, can be adjusted, for example, via the distance between the plasma nozzle and the surface of the workpiece and/or via the working gas flow or working gas pressure of the plasma nozzle.

Furthermore, the displacement of the liquid volume, in particular the degree of displacement, can be influenced by adjusting the liquid height above the workpiece. For example, with lower liquid heights for local liquid displacement, sufficient local water displacement can be achieved with a greater distance between the plasma nozzle and the workpiece or a lower working gas flow or pressure.

In a further embodiment of the method, in particular for cleaning and/or reduction treatment, the workpiece is brought into contact with the liquid by the workpiece being impinged, in particular spraying upon, with the liquid during and/or after impinging with the plasma jet.

The impinging with the liquid may be carried out over the entire surface of the workpiece or locally in the area of the impinging with the plasma jet. By impinging the workpiece surface with the liquid during impinging with the plasma jet, the workpiece can be cooled and/or contact with an oxygen-containing atmosphere can be reduced, for example as long as the workpiece has an increased temperature due to impinging with the plasma jet. Furthermore, the reducing effect of the atmospheric plasma jet can be intensified or generated in the first place by impinging with the liquid, for example by using a liquid with a reducing effect, possibly under the influence of the plasma jet.

The impinging, in particular spraying, of the workpiece may be carried out in a targeted and metered manner. In particular, this embodiment of the method may avoid prolonged contact between the workpiece and the liquid over a large area, as required, which can be advantageous in certain applications or with certain workpiece materials. By impinging during or after the impinging with the plasma jet, a property of the liquid may also be specifically influenced, for example by controlling the temperature of the liquid. In addition, localized impinging has the advantage that less liquid is required.

In a further embodiment of the method for treatment, in particular reduction treatment and/or coating and/or cleaning, the atmospheric plasma jet is generated using a reducing working gas, in particular a hydrogen-containing working gas. The working gas may, for example, contain hydrogen (H₂) and one or more inert gases such as nitrogen (N₂) or noble gases (e.g. Ar). One conceivable working gas is, for example, forming gas, which is a mixture of hydrogen and nitrogen. The forming gas may, for example, have a hydrogen content (H₂) in the range of 1 to 15% by volume and a nitrogen content (N₂) in the range of 99-85% by volume.

When using a hydrogen-containing working gas, the hydrogen it contains, together with the atmospheric plasma jet, has a strong reducing effect on the workpiece or—if it is the liquid which is impinged with the plasma jet—in the liquid. In particular, the plasma jet generated with a hydrogen-containing working gas has a reducing effect on its own, without this having to be caused by other means, such as the liquid. In this way, the liquid may, for example, be a hydrogen-free liquid or a liquid that only contains hydrogen in a strongly bound form, such as an organic liquid.

In the coating method, the reducing effect of the plasma jet may be used in particular to reduce metal ions to elemental metal in order to coat the workpiece with metal. The reduction of the metal ion can be achieved in particular by reactive species, such as OH⁻, which are generated by impinging the liquid with the plasma jet.

In a further embodiment of the method for the treatment, in particular reduction treatment and/or coating and/or cleaning, a hydrogen-containing liquid, preferably a water-containing liquid, in particular water, is used as the liquid. In this way, the liquid can provide hydrogen which, in combination with the atmospheric plasma jet, brings about a strong reducing effect. In this case, it is conceivable, for example, that a non-reducing, e.g. inert, working gas is used to generate the plasma jet, as the reducing effect is caused by the hydrogen from the liquid. For example, air can be used to generate the atmospheric plasma jet, which can keep the operating costs of the method and the apparatus low.

In particular, reactive species, such as OH⁻, with a reducing effect can be generated by impinging the liquid with the plasma jet. In the coating method, for example, metal ions can be reduced to elemental metal by the reactive species.

In one embodiment of the method for the treatment, in particular reduction treatment and/or coating and/or cleaning, an organic liquid is used as the liquid. This is particularly advantageous when treating workpieces made of water-sensitive materials, for example materials susceptible to corrosion, or if liquid water present on the workpiece is disadvantageous for subsequent process steps. In particular, rapid or simple drying of the material surface may be achieved by using an organic liquid, especially when using a highly volatile organic liquid.

The organic liquid may be a bromine-containing solution, for example, whereby a disinfecting effect can be achieved on the surface of the workpiece, in particular in addition to a reduction treatment and/or coating and/or cleaning. This embodiment is therefore particularly relevant, for example, for production methods of workpieces intended for use in medicine or for contact with food.

In one embodiment of the method for the treatment, in particular reduction treatment and/or coating and/or cleaning, the atmospheric plasma jet is generated with a plasma nozzle, wherein the plasma nozzle has a nozzle opening from which the plasma jet emerges during operation. In this way, the plasma jet can be specifically directed, in particular onto the workpiece surface to be treated. In particular, the use of such a plasma nozzle allows targeted treatment, especially reduction treatment and/or coating and/or cleaning, of specific sections of a surface of the workpiece. Furthermore, it is possible in this way to adjust the distance between the nozzle opening of the plasma nozzle and the surface of the workpiece, whereby the treatment effect, in particular reduction effect, coating and/or cleaning, or the displacement of liquid between the surface of the workpiece and the atmospheric plasma jet can be adjusted.

In one embodiment, the plasma nozzle and the workpiece are moved relative to each other during the impinging with the plasma jet. In this way, larger surface areas of a workpiece can be treated, in particular reduced and/or coated and/or cleaned. In addition, targeted treatments, in particular reduction treatments and/or coatings and/or cleaning, can be carried out in certain sections of a surface of the workpiece in this way.

In one embodiment, the atmospheric plasma jet is generated by means of electrical discharges in a working gas. A plasma jet generated in this way can be easily aligned and has proven to be very efficient in reducing oxides on the surfaces of workpieces, particularly metal surfaces, and/or for generating reactive species with a reducing effect. Furthermore, it has been shown that good coating and/or cleaning results can be achieved with such a plasma jet in the coating or cleaning method described. Furthermore, a working gas supply with different gases is possible. In addition, the working gas flow may be adapted to provide sufficient reducing gas for the reduction or redox reaction and/or to achieve the desired liquid displacement between the surface of the workpiece and the atmospheric plasma jet.

In one embodiment of the method for the treatment, in particular reduction treatment and/or coating and/or cleaning, the atmospheric plasma jet is generated by means of an arc-like discharge in a working gas, wherein the arc-like discharge is generated by applying a high-frequency high voltage between electrodes. In this way, a reactive plasma jet with a comparatively low ion temperature is generated, whereby the heating of the workpiece or the liquid when impinged with the plasma jet and the tendency of the workpiece surface to reoxidize or the tendency of metal ions reduced to elemental metal to oxidize can be reduced.

In particular, at least two electrodes may be provided to generate the arc-like electrical discharge, as well as a voltage source to apply a high-frequency high voltage to the electrodes. The high-frequency high voltage for generating a high-frequency arc-like discharge has, in particular, a voltage strength in the range of 1-100 kV, preferably 1-50 kV, more preferably 10-50 kV, and a frequency of 1-300 kHz, in particular 1-100 kHz, preferably 10-100 kHz, more preferably 10-50 kHz.

In one embodiment, a precursor, in particular a metal-containing precursor, is added or has been added to the liquid. The precursor is preferably a salt. Preferably, the salt is or has been dissolved in the liquid. A mixture of different precursors, in particular different salts, may also be added or may have been added to the liquid.

The salt may be a metallic salt in particular. In this way, the surface of the workpiece can be coated with a metal layer. In particular, the metal-containing salt may contain one or more of the following metals: Ag, Cu, Zn, Ni, Sn, Au.

For example, an Ag-containing precursor may be added to the liquid or may contain an Ag-containing precursor, the Ag-containing precursor preferably being selected from the following list: silver acetate (CH₃CO₂Ag), silver carbonate (Ag₂CO₃), silver chloride (AgCl), silver iodide (AgI), silver nitrate (AgNO₃), silver perchlorate monohydrate (AgClO₄·H₂O), silver sulphate (Ag₂SO₄), silver bromide (AgBr), silver trifluoroacetate (CF₃COOAg), silver chromate (Ag₂CrO₄), silver sulphide (Ag₂S), silver citrate (C₆H₅Ag₃O₇), mixtures of two or more of the abovementioned compounds, mixtures containing at least one of the abovementioned compounds.

For example, a Cu-containing precursor may be added to the liquid or may contain a Cu-containing precursor, the Cu-containing precursor preferably being selected from the following list: bis(2,4-pentanedionato)copper(II) (C₁₀H₁₄CuO₄), copper(II)-2-ethylhexanoate (C₁₆H₃₀CuO₂), copper glycinate, tetraamine copper sulfate-1-hydrate, copper(II) acetate hydrate, copper(II) acetate anhydrate, copper(II) bromide, copper(II) carbonate, copper(II) chloride, copper(II) chloride dihydrate, copper(II) chloride anhydrate, copper(II) chloride solution, copper(II) citrate hemi-trihydrate, copper(II) formate-4-hydrate, copper(II)gluconate, copper(II)nitrate-3-hydrate, copper(II)nitrate solution, copper(II)oxalate-1/2-hydrate, copper(II)phosphate, copper(II)sulphate-1-hydrate, copper(II)sulphate-5-hydrate, copper(II)sulphate anhydrate, copper(I) bromide, copper(I) chloride, copper(I) iodide, copper(I) oxide, mixtures of two or more of the aforementioned compounds, mixtures containing at least one of the aforementioned compounds.

For example, a Zn-containing precursor may be added to the liquid or contain a Zn-containing precursor, whereby the Zn-containing precursor is preferably selected from the following list: zinc acetate-2-hydrate, zinc acetate anhydrate, zinc ascorbate, zinc asparate, zinc bromide anhydrate, zinc bromide solution, zinc carbonate, zinc chloride anhydrate, zinc citrate-2-hydrate, zinc citrate-3-hydrate, zinc formate anhydrate, zinc gluconate, zinc glycinate, zinc lactate-2-hydrate, zinc nitrate-6-hydrate, zinc picolinate, zinc sulphate-1-hydrate, zinc sulphate-7-hydrate, mixtures of two or more of the aforementioned compounds, mixtures containing at least one of the aforementioned compounds.

For example, a Ni-containing precursor may be added to the liquid or contain a Ni-containing precursor, the Ni-containing precursor preferably being selected from the following list: ammonium nickel(II)sulphate-6-hydrate, nickel(II)acetate-4-hydrate, nickel(II)bromide anhydrate, nickel(II)bromide hydrate, nickel(II)bromide solution, nickel(II)carbonate, nickel(II)chloride-6-hydrate, nickel(II)chloride anhydrate, nickel(II)chloride solution, nickel(II)citrate hydrate, nickel(II)formate-2-hydrate, nickel(II)gluconate, nickel(II)glycinate, nickel(II)lactate-4-hydrate, nickel(II)nitrate-6-hydrate, nickel(II)nitrate solution, nickel sulfamate solution, nickel sulfate-6-hydrate, nickel sulfate solution, mixtures of two or more of the above compounds, mixtures containing at least one of the above compounds.

For example, a Sn-containing precursor may be added to the liquid or contain a Sn-containing precursor, whereby the Sn-containing precursor is preferably selected from the following list: tin(IV)chloride, tin(II)bromide, tin(II)chloride, tin(II)fluoride, tin(II)iodide, tin(II)oxalate, tin(II)pyrophosphate, tin(II)selenide, tin(II)sulfate, tin(II)sulfide, tin(II)telluride, tin(IV)bromide, tin(IV)fluoride, tin(IV)iodide, tin(IV)sulfate, tin(IV)sulfate dihydrate, tin(IV)sulfide, mixtures of two or more of the aforementioned compounds, mixtures containing at least one of the aforementioned compounds.

For example, an Au-containing precursor may be added to the liquid or may contain an Au-containing precursor, the Au-containing precursor preferably being selected from the following list: gold(III)chloride, gold(I)chloride, gold(III)chloride trihydrate, gold(V)fluoride, gold(I)acetylide, gold(I)azide, gold(I)bromide, gold(I)cyanide, gold(I)iodide, gold(I)oxide, gold(I)sulfide, gold(I)thiocyanate, gold(III)bromide, gold(III)chloride, gold(III)fluoride, gold(III)iodide, gold(III)selenate, gold(III)sulfide, mixtures of two or more of the aforementioned compounds, mixtures containing at least one of the aforementioned compounds.

In particular, the liquid is a solvent for the salt. In particular, the liquid may be selected from the following list of liquids: water, alcohols, such as ethanol, methanol or isopropanol, ketones, such as acetone, acids, such as organic acids or inorganic acids, dimethyl sulfoxide, amino-based solvents, such as pyridine, propionitrile or ammonia, mixtures of two or more of the aforementioned solvents, mixtures containing at least one of the aforementioned solvents. Preferably, a liquid, in which the selected precursor has good solubility, may be selected as solvent.

The liquid may be heated, for example to a temperature above 30° C., preferably above 50° C., in order to increase the solubility of the precursors described above in the liquid.

Further additives may be added to the liquid, for example to create a buffer solution to stabilize the pH value. When using a salt as a precursor, for example, a weak acid corresponding to the salt may be added to the liquid to produce a buffer solution, such as carbonic acid when using a metal carbonate such as tin carbonate as a precursor or citric acid when using a metal citrate such as copper(II) citrate as a precursor.

### BRIEF DESCRIPTION OF THE DRAWINGS

The terms Fig., Figs., Figure, and Figures are used interchangeably in the specification to refer to the corresponding figures in the drawings.

Further features and advantages of the methods and the apparatus emerge from the following description of exemplary embodiments, with reference being made to the attached drawing.

In the drawing

FIG. 1 shows a plasma nozzle for generating an atmospheric plasma jet,

FIG. 2 shows a first exemplary embodiment of the method for the reduction treatment of a workpiece,

FIG. 3 shows a second exemplary embodiment of the method for the reduction treatment of a workpiece,

FIG. 4 shows a third exemplary embodiment of the method for the reduction treatment of a workpiece,

FIG. 5 shows a fourth exemplary embodiment of the method for the reduction treatment of a workpiece,

FIG. 6 shows an exemplary embodiment of the apparatus for the reduction treatment and/or coating and/or cleaning of a strip-shaped workpiece and a further exemplary embodiment of the method for the reduction treatment and/or coating and/or cleaning using this apparatus,

FIG. 7 shows an exemplary embodiment of the method for coating and possibly cleaning a workpiece,

FIG. 8 shows a photograph of a workpiece coated using the method according to FIG. 7 and

FIG. 9 shows a photograph of another workpiece coated using the method shown in FIG. 7.

### DESCRIPTION OF THE INVENTION

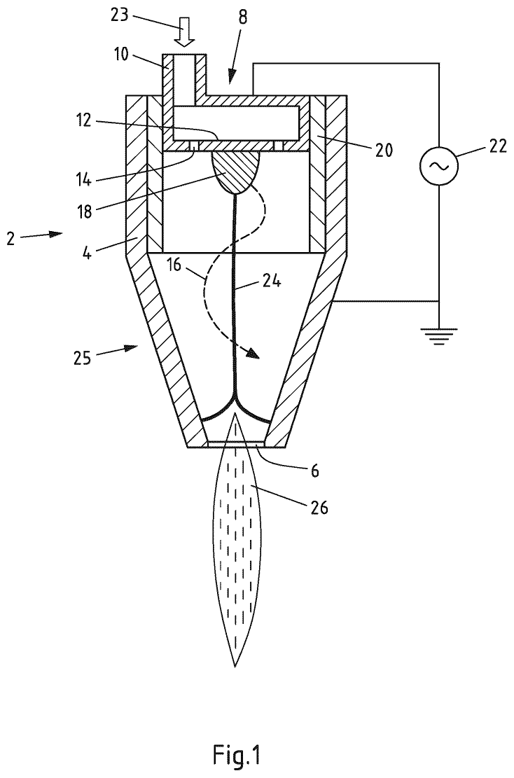

Before the exemplary embodiments of the methods and apparatuses are discussed, the structure and operating principle of a suitable plasma source shown in FIG. 1 will be explained.

FIG. 1 shows a plasma source in the form of a plasma nozzle 2 for generating an atmospheric plasma jet 26.

The plasma nozzle 2 has a metal nozzle tube 4 that tapers conically to a nozzle opening 6. At the end opposite the nozzle opening 6, the nozzle tube 4 has a swirl device 8 with an inlet 10 for a gas flow, in particular a working gas, for example nitrogen, air or forming gas.

An intermediate wall 12 of the swirl device 8 has a ring of holes 14 set at an angle in the circumferential direction, through which the gas flow is swirled. The downstream, conically tapered part of the nozzle tube is therefore flowed through by the gas flow in the form of a vortex 16, the core of which runs along the longitudinal axis of the nozzle tube. An electrode 18 is arranged centrally on the underside of the intermediate wall 12, which projects coaxially into the nozzle tube in the direction of the tapered section. The electrode 18 is electrically connected to the intermediate wall 12 and the other parts of the swirl device 8. The swirl device 8 is electrically insulated from the nozzle tube 4 by a ceramic tube 20. A high-frequency high voltage, which is generated by a transformer 22, is applied to the electrode 18 via the swirl device 8. The inlet 10 is supplied with a working gas flow 23 via a line not shown. The nozzle tube 4 is earthed. The applied voltage generates a high-frequency discharge in the form of an arc 24 between the electrode 18 and the nozzle tube 4. The electrode 18 connected to the transformer and the earthed nozzle tube 4 thus represent discharge means 25, which are configured to generate a high-frequency high-voltage discharge in the form of the arc 24, i.e. an arc-like discharge, in a gas flow 23.

The terms “arc”, “arc discharge” or “arc-like discharge” are used here as a phenomenological description of the discharge, as the discharge occurs in the form of an arc. The term “arc” is also used elsewhere as a form of discharge for DC discharges with essentially constant voltage values. In the present case, however, we are dealing with a high-frequency discharge in the form of an arc, i.e. a high-frequency, arc-like discharge.

Due to the swirling flow of the working gas, this arc is however channeled in the vortex core on the axis of the nozzle tube 4, so that it only branches out towards the wall of the nozzle tube 4 in the area of the nozzle opening 6. The working gas, which rotates at high flow velocity in the area of the vortex core and thus in the immediate vicinity of the arc 24, comes into intimate contact with the arc and is thus partially converted into the plasma state, so that an atmospheric plasma jet 26 emerges from the plasma nozzle 2 through the nozzle opening 6.

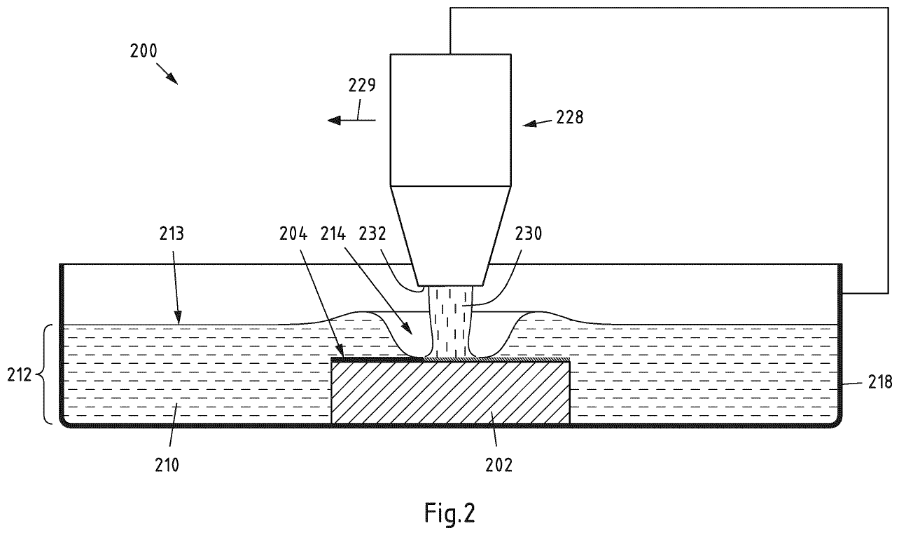

FIG. 2 shows a schematic representation of a first exemplary embodiment of the method for the reduction treatment of a workpiece 202.

In the method 200, a liquid volume 212 of a liquid 210 is provided in a container 218 provided for this purpose and the workpiece 202 to be treated is arranged in the liquid 210 and in particular submerged, so that the surface 204 of the workpiece 202 to be reduced is acted upon by the liquid 210, in particular covered by the liquid 210, for example with a covering height of 5 mm. Preferably, the surface 204 of the workpiece 202 to be treated is oriented towards the liquid surface 213 of the liquid volume 212. The liquid 210 may, for example, be a hydrogen-containing liquid, preferably a water-containing liquid, in particular water, or an organic liquid.

By means of a plasma nozzle 228 provided, which may be configured, for example, like the plasma nozzle 2 shown in FIG. 1, an atmospheric plasma jet 230 is generated by a high-frequency high-voltage discharge in a working gas, which emerges from a nozzle opening 232 of the plasma nozzle 228. The working gas may be a reducing working gas, in particular forming gas, or a non-reducing working gas, for example air.

The plasma jet 230 is directed towards the surface 204 of the workpiece 202 to be reduced, which in this exemplary embodiment is submerged. In this exemplary embodiment, the working gas flow of the plasma nozzle 228 is adjusted such that the atmospheric plasma jet 230 locally practically completely displaces the liquid 210 between the plasma nozzle 228 and the surface 204, so that no liquid or only a thin liquid film remains in a treatment area 214 on the surface 204 of the workpiece 202, so that the surface 204 in the treatment area 214 is practically directly impinged with the plasma jet 230.

By impinging the surface 204 of the workpiece 202 with the atmospheric plasma jet 230, the surface is subjected to a reduction treatment, in which oxides present there, possibly also a continuous oxide layer (shown schematically in the figures by a thick black line on the workpiece surface), are effectively reduced, so that, after impinging with the atmospheric plasma jet 230, the surface 204, in the treatment area 214, has a reduced surface area with a significantly lower oxide content or completely without oxides (shown schematically in the figures by a hatched area on the workpiece surface).

The plasma nozzle 228 and the workpiece 202 are moved relative to each other so that the surface 204 of the workpiece may be reduced in predetermined sections or completely, so that a reduced workpiece surface remains. In FIG. 2, for example, the plasma nozzle 228 is moved relative to the workpiece 202 using a traversing device 229.

By impinging with the atmospheric plasma jet 230, thermal energy is introduced locally into the workpiece 202, in particular at the surface 204 of the workpiece 202 in the treatment area 214. This heat can be effectively dissipated by contact with the liquid 210, in particular when the liquid 210, which flows back into the previously impinged area when the plasma nozzle is switched off or moved, covers the former treatment area again.

In this way, the treatment area 214 is acted upon by the liquid 210 immediately after the reduction treatment and is thus cooled efficiently. In addition, contact with any oxygen-containing atmosphere is reduced, in particular prevented, by the liquid flowing back, as a result of which reoxidation is immediately inhibited, in particular until the workpiece has cooled down sufficiently.

In particular, the distance between the plasma nozzle 228 and the surface 204 of the workpiece 202 can be adjusted in order to displace sufficient liquid 210 and cause direct impinging of the workpiece surface 204 with the plasma jet 230. Additionally or alternatively, the working gas flow or the pressure of the working gas introduced into the plasma nozzle 228 can be adjusted. Furthermore, the volume of liquid 212 present between the surface 204 of the workpiece 202 and the plasma nozzle 228 can be adjusted via the filling quantity of the container 218 with the liquid 210 and/or via the arrangement of the workpiece 202.

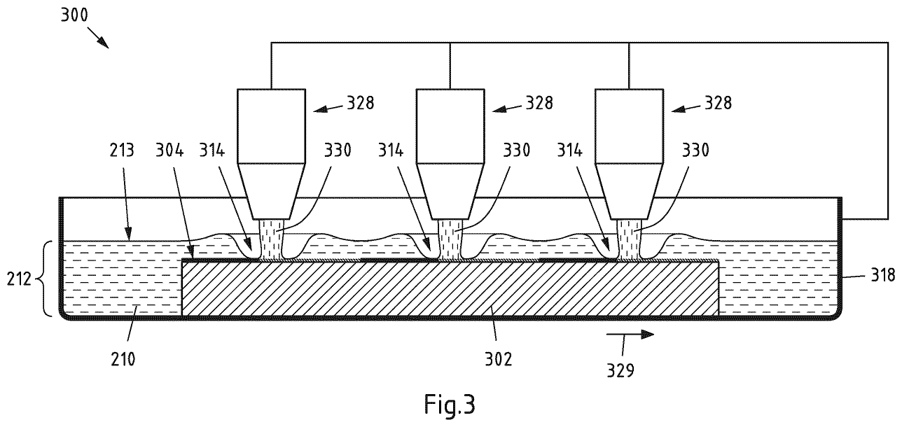

FIG. 3 shows a schematic representation of a further exemplary embodiment of the method for the reduction treatment of a workpiece 302. The method 300 shown in FIG. 3 is similar to the method 200 shown in FIG. 2. Corresponding components are marked with the same reference numerals and reference is made in this respect to the explanations of FIG. 2.

The method 300 differs from the method 200 in that a plurality of plasma nozzles 328 are provided for generating a respective atmospheric plasma jet 330, so that a larger area of the workpiece surface 304 of the workpiece 302 can be subjected to a reduction treatment simultaneously in respective treatment areas 314. The plasma nozzles 328 can each have a structure and a mode of operation like the plasma nozzle 2 of FIG. 1.

The plasma nozzles 328 and the workpiece 302 are moved relative to one another, so that the surface 304 of the workpiece 302 can be reduced in predetermined sections or completely, so that a reduced workpiece surface remains. In FIG. 3, for example, the container 318 with the workpiece is moved relative to the plasma nozzles 328 using a traversing device 329.

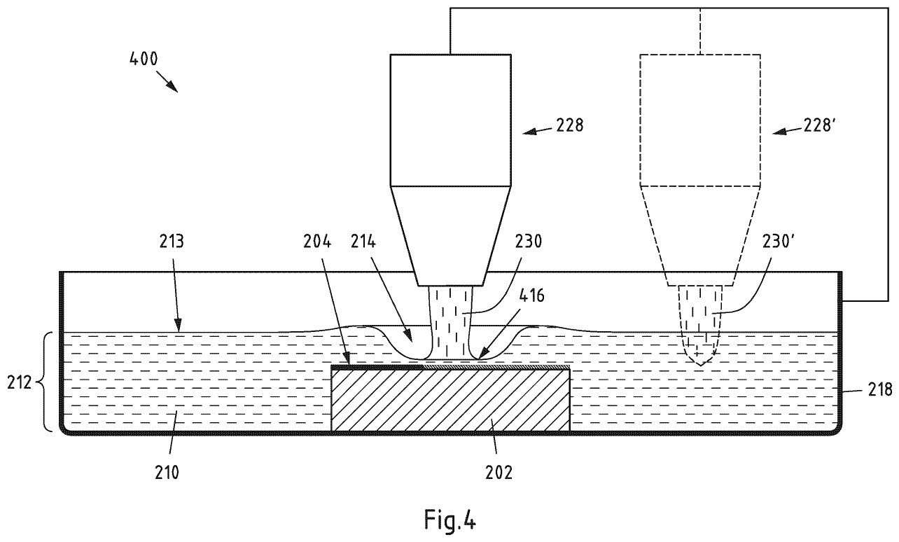

FIG. 4 shows a schematic representation of a further exemplary embodiment of the method for the reduction treatment of a workpiece 202. The method 400 shown in FIG. 4 is similar to the method 200 shown in FIG. 2. Corresponding components are provided with the same reference numerals and reference is made in this respect to the explanations relating to FIG. 2.

The method 400 differs from the method 200 in that the distance between the plasma nozzle 228 and the workpiece 202 and/or the working gas flow or pressure for supplying the plasma nozzle 228 are set such that the liquid 210 between the plasma nozzle 228 and the surface 204 of the workpiece 202 is displaced in the treatment area 214 only to such an extent that a macroscopic liquid film 416 still remains on the workpiece surface 204 in the treatment area 214. The plasma jet 230 therefore impinges in particular on the liquid 210 of the liquid film 416.

In this way, the liquid 210 of the liquid film 416 is excited or activated by the atmospheric plasma jet 230. A reducing effect of this activated liquid 210 has been found, so that oxides on the surface 204 of the workpiece 202 in the treatment area 214 are effectively reduced. Such indirect acting upon the surface 204 of the workpiece 202 due to the liquid film 416 remaining between the surface 204 of the workpiece 202 and the atmospheric plasma jet 230 can thus also be used to perform a reduction treatment of a workpiece.

The fact that the surface 204 of the workpiece 202 is covered by the liquid film 416 during the reduction treatment means that the thermal energy introduced by the plasma jet 230 can be absorbed and dissipated by the liquid 210, so that no significant heating of the workpiece 202 occurs. In addition, contact with the oxygen-containing atmosphere is prevented and reoxidation is inhibited particularly effectively overall.

Furthermore, tests have shown that the reducing effect when the liquid 210 is impinged with the plasma jet 230 is not limited locally to an immediate treatment area 214 in which the plasma jet 230 acts on the liquid 210. Rather, a reducing effect of the liquid 210 impinged with the plasma jet 230 was also observed at a distance from the plasma jet 230, presumably because reducing species generated in the liquid 210 by the plasma jet 230 are distributed in the liquid 210.

Therefore, the liquid 210—as an alternative to being impinged directly in the region of the surface 204 of the workpiece 202—can also be impinged with the plasma jet 230 remote from the surface 204 of the workpiece 202, as shown schematically in FIG. 4 by the position of the plasma nozzle 228′ shown in dashed lines. In this embodiment, the liquid 210 is impinged with the plasma jet 230′ emerging from the plasma nozzle 228′ at a distance from the workpiece surface 204. Tests have shown that such an impact on the liquid 210 gives it a reducing effect, so that the workpiece surface 204 is reduced. With this embodiment, it is also possible, for example, to subject several workpieces 202 arranged in the liquid volume 212 to a reduction treatment at the same time in order to remove oxides from their respective workpiece surfaces 204.

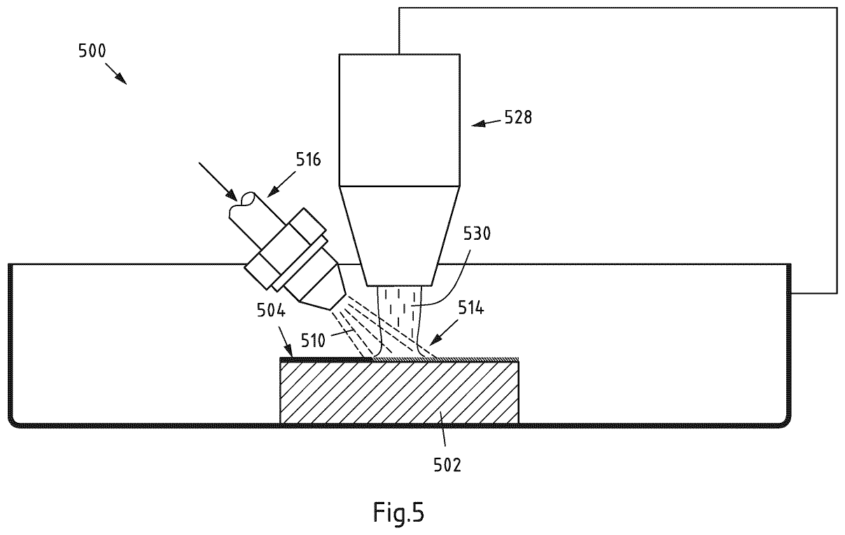

FIG. 5 shows a schematic representation of a further embodiment of the method for the reduction treatment of a workpiece 502.

In the method 500, a workpiece 502 having a surface 504 to be reduced is arranged such that the surface 504 of the workpiece 502 is accessible.

An atmospheric plasma jet 530 is generated by means of a plasma nozzle 528, which may be configured, for example, like the plasma nozzle 2 shown in FIG. 1, and directed towards the workpiece surface 504 so that this is impinged with the plasma jet 530 in a treatment area 514. To generate the plasma jet 530, the plasma nozzle 528 is supplied with a hydrogen-containing working gas, for example forming gas. The plasma jet 530 thus has a reducing effect, so that oxides present on the workpiece surface 504 are reduced.

During and/or after impinging with the atmospheric plasma jet 530, the workpiece surface 504 is impinged with a liquid 510, in particular sprayed, by means of a spraying device 516. In this way, thermal energy introduced by the atmospheric plasma jet 530 can be effectively dissipated from the workpiece surface 504, so that the workpiece surface 504 heats up less, thereby reducing the susceptibility to reoxidation. In addition, the reduced workpiece surface 504 is covered by the liquid 510, thereby reducing contact with the oxygen-containing atmosphere and thus further inhibiting reoxidation.

The flow rate of the liquid 510 is preferably set at the spraying device 516 in such a way that the treatment area 514 is completely impinged with the liquid 510 and in this way sufficient cooling of the workpiece 502 at the workpiece surface 504 is achieved.

The liquid 510 may be water, for example. It was found that in this embodiment, the use of a hydrogen-containing working gas for the plasma nozzle 528 can even be dispensed with and an inert gas or air can be used instead, since the hydrogen contained in the water in combination with the plasma jet 530 already leads to a reducing effect.

Alternatively, the liquid 510 may also be an organic liquid, for example if the workpiece surface 504 is sensitive to water or should dry quickly after the reduction treatment.

The plasma nozzle 528 and the workpiece 502 may be moved relative to each other in order to subject the workpiece surface 504 to a reduction treatment in predetermined sections or completely. If the plasma nozzle 528 is moved, the spraying device 516 is preferably also moved and/or the orientation of the spraying device 516 is adjusted in such a way that the treatment area 514 continues to be impinged with the liquid 510.

In another embodiment, not shown, the method 500 may be performed using multiple plasma sources 528 and/or multiple spray devices 516, similar to the method 300 shown in FIG. 3.

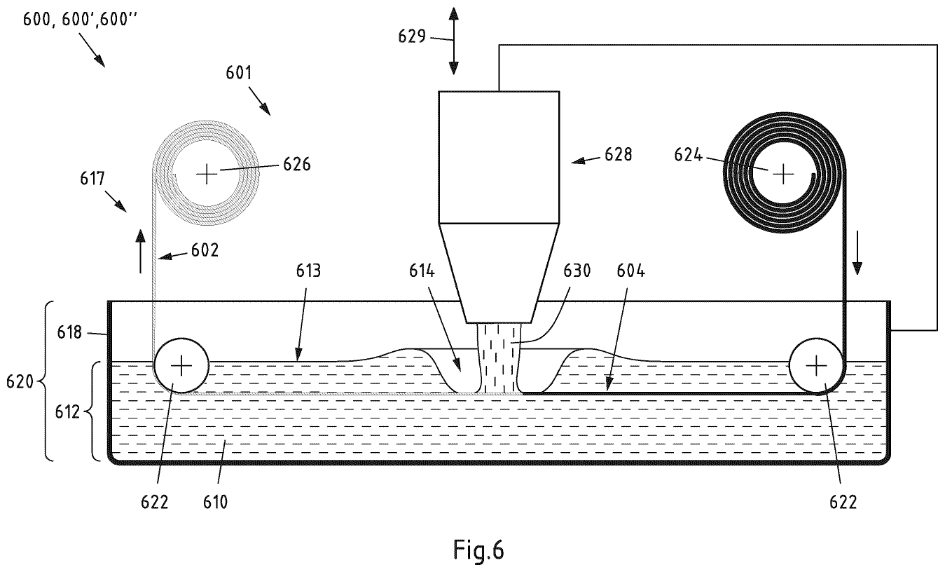

FIG. 6 shows an exemplary embodiment of the apparatus for the reduction treatment and/or coating and/or cleaning of a strip-shaped workpiece.

The apparatus 601 comprises an immersion bath device 617 with an immersion basin 618 for holding a liquid volume 612 of a liquid 610, which thus forms an immersion bath 620. The immersion basin 618 is open at the top so that a strip-shaped workpiece 602 can be introduced into the immersion bath 620 and led out again and, for example, inline integration into a continuous production process is possible.

The immersion bath device 617 further comprises guide means 622, which are arranged and configured for guiding a strip-shaped workpiece 602 through the immersion bath 620. Preferably, the guide means 622 are arranged and configured such that the strip-shaped workpiece 602 can, during operation, be guided at least in sections, in particular at least in a treatment region 614, completely below the surface 613 of the liquid volume 612, so that a workpiece surface 604 of the strip-shaped workpiece 602 to be reduced and/or coated and/or cleaned is covered by the liquid 610 in the treatment region 614. In the present example, the guide means 622 are designed as guide rollers.

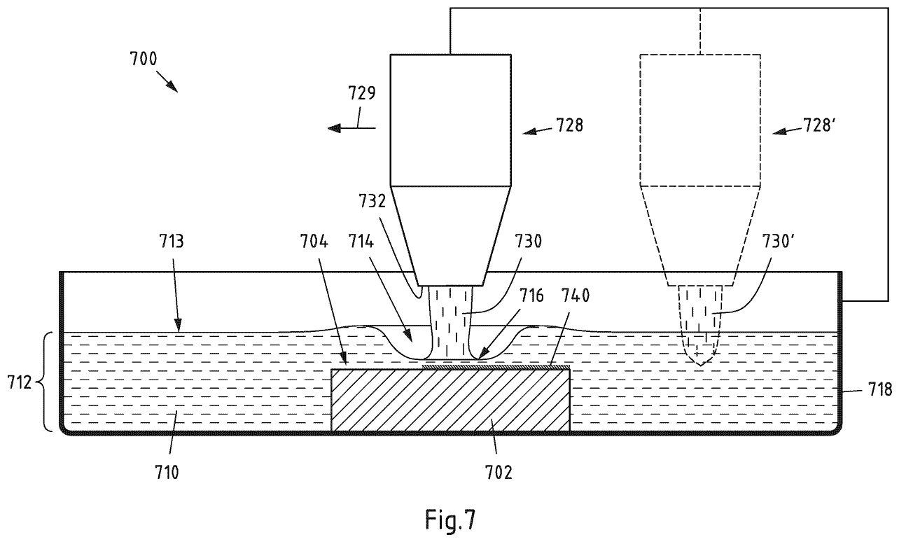

Furthermore, the apparatus 601 comprises a plasma source 628 in the form of a plasma nozzle for generating an atmospheric plasma jet 630, which may be configured, for example, like the plasma nozzle 2 of FIG. 1. The plasma nozzle 628 is arranged and configured in such a way that, during operation, the atmospheric plasma jet emerging from the plasma nozzle 628 is directed towards the workpiece surface 604 in the treatment area 614 of the strip-shaped workpiece 602 guided through the immersion bath 620 by the guide means 622. The distance between the plasma nozzle 628 and the workpiece surface 604 of the strip-shaped workpiece 602 (traversing device 629) and/or the working gas flow or pressure of the plasma nozzle 628 can be adapted such that the liquid 610 in the treatment area is displaced practically completely (as shown in FIG. 6) or partially (analogous to FIG. 4 or 7), such that the workpiece surface 604 can be subjected to a reduction treatment and/or coating and/or cleaning by direct impinging with the plasma jet 630 and/or by impinging the liquid 610 in the area of the workpiece surface 604.

In an alternative embodiment, the plasma nozzle 628 may be arranged such that the plasma jet 630 is directed towards the liquid 610 remote from the strip-shaped workpiece 602 (analogous to the plasma nozzle 228′ shown in dashed lines in FIG. 4).

Furthermore, the apparatus 601 may have dispensing means 624 for dispensing the strip-shaped workpiece 602 with the workpiece surface 604 to be reduced and/or coated and/or cleaned and/or receiving means 626 for receiving the strip-shaped workpiece 602 after the reduction treatment. In the present example, the dispensing and receiving means 624, 626 are designed as, preferably driven, rollers, so that the strip-shaped workpiece 602 is unrolled from the dispensing means 624 for dispensing and rolled onto the receiving means 626 for receiving.

In the case of driven dispensing and receiving means 624, 626, these also represent transport means for transporting the strip-shaped workpiece 602 through the immersion bath 620. The transport means can also be formed by the guide means 622 if these are driven.

The apparatus 601 can be used to perform a method 600 for the reduction treatment of the strip-shaped workpiece 602 by guiding the workpiece 602 through the immersion bath 620 by means of the transport means and impinging the surface 604 to be reduced and/or the liquid 610 with the plasma jet 630. In this way, an oxide layer can be reduced from the surface of the strip-shaped workpiece 602. In FIG. 6, the workpiece with oxide layer is shown schematically as a black strip and the reduced workpiece as a hatched strip.

The apparatus 601 can additionally or alternatively be used to perform a method 600′ for coating the strip-shaped workpiece 602 by guiding the workpiece 602 through the immersion bath 620 by means of the transport means and impinging the surface 604 to be coated and/or the liquid 610 with the plasma jet 630. A metal salt is dissolved in the liquid 610 for the coating. Due to the reactive species generated in the liquid 610 by the plasma jet 630, the metal ion of the metal salt dissociated in the liquid is reduced to elemental metal and is deposited on the surface of the strip-shaped workpiece 602 as a metal layer. In this way, the surface of the strip-shaped workpiece 602 can be coated with a metal layer.

The apparatus 601 can additionally or alternatively be used to perform a method 600″ for cleaning the strip-shaped workpiece 602 by guiding the workpiece 602 through the immersion bath 620 by means of the transport means and impinging the surface 604 to be cleaned and/or the liquid 610 with the plasma jet 630. The reactive species generated in the liquid 610 by the plasma jet 630 can interact with impurities on the surface of the strip-shaped workpiece 602 to be cleaned and chemically decompose them and/or detach them from the surface. In this way, the surface of the strip-shaped workpiece 602 can be cleaned.

FIG. 7 shows a schematic representation of a first exemplary embodiment of the method for coating and, if necessary, cleaning a workpiece 702.

In the method 700, a liquid volume 712 of a liquid 710 is provided in a container 718 provided for this purpose and the workpiece 702 to be treated is arranged in the liquid 710 and in particular submerged, so that the surface 704 of the workpiece 702 to be coated is acted upon by the liquid 710, in particular is covered by the liquid 710, for example with a covering height of 5 mm. Preferably, the surface 704 of the workpiece 702 to be coated is oriented towards the liquid surface 713 of the liquid volume 712.

A metal salt is dissolved in the liquid 710 as a precursor, for example an Ag, Cu, Zn, Ni, Sn or Au salt. The liquid is a solvent for the metal salt. Depending on the metal salt used, the liquid 710 may be, for example, water, alcohol, such as ethanol, methanol or isopropanol, a ketone, such as acetone, an acid, such as organic acids or inorganic acid, dimethyl sulfoxide, an amino-based solvent, such as pyridine, propionitrile or ammonia, or a mixture of two or more of the aforementioned solvents. In order to increase the solubility of the metal salt in the liquid 710, the liquid 710 may also be heated, for example to a temperature above 30° C., preferably above 50° C. Furthermore, other substances may be added to the liquid 710, for example a weak acid corresponding to the metal salt, in order to produce a buffer solution for stabilizing the pH value.

By means of a plasma nozzle 728 provided, which may be configured, for example, like the plasma nozzle 2 shown in FIG. 1, an atmospheric plasma jet 730 is generated by a high-frequency high-voltage discharge in a working gas, which emerges from a nozzle opening 732 of the plasma nozzle 728. The working gas may be a reducing working gas, in particular forming gas, or a non-reducing working gas, for example air.

The plasma jet 730 is directed towards the surface 704 of the workpiece 702 to be coated, which in this exemplary embodiment is submerged. In this exemplary embodiment, the working gas flow or pressure for supplying the plasma nozzle 728 is set such that the liquid 710 between the plasma nozzle 728 and the surface 704 of the workpiece 702 in the treatment area 714 is only displaced to such an extent that a macroscopic liquid film 716 still remains on the workpiece surface 704 in the treatment area 714. Accordingly, the plasma jet 730 impinges in particular the liquid 710 of the liquid film 716. Alternatively, the working gas flow or pressure for supplying the plasma nozzle 728 can also be set such that only a microscopic liquid film remains on the workpiece surface 704 in the treatment area 714.

By impinging the liquid 710 or the liquid film 716 with the plasma jet, a redox reaction occurs on the metal cation of the salt dissociated in the liquid. In this way, the metal cation (e.g. Cu²⁺) is reduced to elemental metal (e.g. Cu) in the area of the workpiece surface 704 and in this way forms a metal layer 740 on the workpiece surface 704. For example, the redox reaction can proceed as follows:

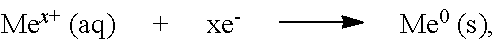

where Me^{x+} (aq) denotes an x-fold ionized metal ion dissolved in water, xe⁻ denotes x electrons and Me⁰ (s) denotes the reduced metal as a solid. The electrons can be made available in particular by OH⁻, which are produced by impinging the liquid 710 with the plasma jet 730, for example according to the reaction equation

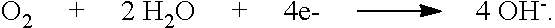

This means that the redox reaction can proceed as follows, for example:

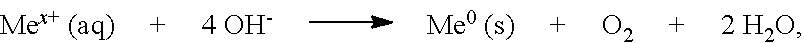

The plasma nozzle 728 and the workpiece 702 are moved relative to each other so that the surface 704 of the workpiece can be coated in predetermined sections or even completely, so that a reduced workpiece surface remains. In FIG. 7, for example, the plasma nozzle 728 is moved relative to the workpiece 702 using a traversing device 729.

Because the surface 704 of the workpiece 702 is covered by the liquid film 716 during coating, the thermal energy introduced by the plasma jet 730 can be absorbed and dissipated by the liquid 710, so that no significant heating of the workpiece 702 occurs. In addition, contact with the oxygen-containing atmosphere is prevented by the liquid film 716. In this way, oxidation of the elementary metal formed during the redox reaction or the formation of oxides on the coated surface can be inhibited, particularly until the workpiece has cooled down sufficiently.

Furthermore, tests have shown that the coating caused by the redox reaction on the precursor when the liquid 710 is impinged with the plasma jet 730 is not limited locally to an immediate treatment area 714 in which the plasma jet 730 acts on the liquid 710. Rather, a redox reaction can also be achieved on the precursor at a distance from the plasma jet 730 and thus a coating of the workpiece surface 704 can be detected, presumably because reducing species generated in the liquid 710 by the plasma jet 730, such as OH⁻, are distributed in the liquid 710 and can thus also reduce metal ions to elemental metal at a distance from the plasma jet 730.

Therefore, the liquid 710—as an alternative to being impinged directly in the area of the surface 704 of the workpiece 702—may also be impinged with the plasma jet 730 remote from the surface 704 of the workpiece 702, as shown schematically in FIG. 7 by the position of the plasma nozzle 728′ shown in dashed lines. In this embodiment, the liquid 710 is impinged with the plasma jet 730′ emerging from the plasma nozzle 728′ at a distance from the workpiece surface 704. Experiments have shown that such impinging of the liquid 710 gives it a reducing effect, so that metal ions are reduced to elemental metal in the area of the workpiece surface 704, which is then deposited on the workpiece surface 704. With this embodiment, it is also possible, for example, to coat several workpieces 702 arranged in the liquid volume 712 at the same time.

The species generated in the liquid 710 by the plasma jet 730, such as OH⁻, can also interact with any impurities, for example organic impurities, on the workpiece surface 704, in particular chemically converting them and/or dissolving them from the workpiece surface 704. In this way, cleaning of the workpiece surface 704 can also be achieved, in particular before it is coated.

In principle, a coating of a workpiece may also be achieved with one of the embodiments of the method described with reference to FIGS. 2-5, for example by adding a precursor, in particular a salt, for example metal salt, in particular by introducing it into the liquid or dissolving it therein. Furthermore, the exemplary embodiments of the method shown in FIGS. 2-5 may also be used to clean the surface of the workpiece.

Experiments were carried out to test the coating method shown in FIG. 7.

### Experiment 1

A card made of the plastic acrylonitrile butadiene styrene (ABS) was coated with silver. For this purpose, the uncoated card was placed in the liquid volume 712 (see FIG. 7) so that the upper side of the card to be coated was covered with a macroscopic liquid film of a few millimeters. In experiment 1, the liquid 710 was water (H₂O), in which the metal salt silver nitrate (AgNO₃) was dissolved as a precursor at a concentration of 5 g AgNO₃ per 100 mL H₂O.

The plasma nozzle 728 was operated with nitrogen (N₂) as the working gas and the plasma jet was directed at the liquid film 716 above the surface of the card to be coated and moved at a relative speed of 0.5 m/min. relative to the surface of the card. To achieve a greater coating thickness, the surface of the card was traversed three times with the plasma jet.

After completion of the method, the surface of the card had a silver-colored coating. This coating was analyzed by LIBS (Laser Induced Breakdown Spectroscopy) using a Microscope EA300 type LIBS device, distributed by Keyence Deutschland GmbH. The LIBS device was used to examine the element-specific composition of the coating at several points (9 points in a 3×3 grid). It was determined that the coating was a layer of silver. Furthermore, the ohmic resistance of the coating was measured using a multimeter and it was determined that the coating was electrically conductive, i.e. that it was an electrically conductive silver coating.

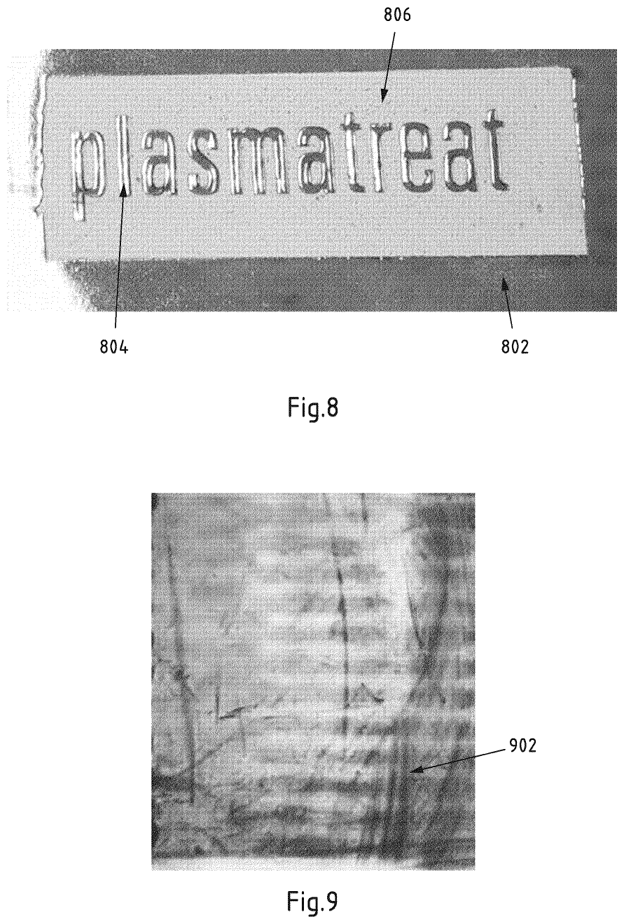

A photograph of the silver-coated card is shown in FIG. 8. The coating can be seen in the form of lettering (arrow 802) and a surrounding frame (arrow 804). The uncoated area (arrow 806) between the lettering and the frame was created by a mask that was glued to the card before the coating method and removed again after the coating method.

### Experiment 2

Another card made of the plastic acrylonitrile butadiene styrene (ABS) was coated with copper. For this purpose, the uncoated card was placed in the liquid volume 712 (see FIG. 7) so that the upper side of the card to be coated was covered with a macroscopic liquid film of a few millimeters. In experiment 2, the liquid 710 was ethanol, in which a silver salt with a concentration of 5 g AgNO₃ per 100 mL solution was dissolved as a precursor.

The plasma nozzle 728 was operated with nitrogen (N₂) as the working gas and the plasma jet was directed at the liquid film 716 above the surface of the card to be coated and moved at a relative speed of 0.5 m/min. relative to the surface of the card.

At the end of the method, the surface of the card had a thin yellow-reddish coating. This coating was examined by means of LIBS (Laser Induced Breakdown Spectroscopy) using a Microscope EA300 type LIBS device, distributed by Keyence Deutschland GmbH. The LIBS device was used to examine the element-specific composition of the coating at several points (9 points in a 3×3 grid). It was determined that the coating was a layer of copper. Furthermore, the ohmic resistance of the coating was measured using a multimeter and it was determined that the coating was electrically conductive, i.e. it was a thin electrically conductive copper layer.

A photograph of the copper-coated card is shown in FIG. 9. The coating (arrow 902) shows a slightly visible stripe structure corresponding to the path of the plasma jet over the surface of the card. This structure disappears when the coating thickness is increased, for example by passing the plasma jet over the surface several times.

### LIST OF REFERENCE SYMBOLS

| | |
|---|---|
| 2, 228, 228′, 328, 528, 628, 728, 728′ | plasma nozzle |
| 4 | nozzle tube |
| 6, 232, 732 | nozzle opening |
| 8 | swirl device |
| 10 | inlet |
| 12 | intermediate wall |
| 14 | holes |
| 16 | vortex |
| 18 | electrode |
| 20 | ceramic tube |
| 22 | transformer |
| 23 | gas flow |
| 24 | electric arc |
| 25 | discharge means |
| 26, 230, 230′, 330, 530, 630, 730, 730′ | plasma jet |
| 200, 300, 400, 500, 600, 600′, 600″, 700 | method |
| 202, 302, 502, 602, 702 | workpiece |
| 204, 304, 504, 604, 704 | workpiece surface |
| 210, 510, 610, 710 | liquid |
| 212, 612, 712 | liquid volume |
| 213, 613, 713 | liquid surface |
| 214, 314, 514, 614, 714 | Treatment area |
| 218, 718 | Container |
| 229, 329, 629, 729 | traversing device |
| 416, 716 | liquid film |
| 516 | spraying device |
| 601 | apparatus |
| 617 | immersion bath device |
| 618 | immersion basin |
| 620 | immersion bath |
| 622 | guide means |
| 624 | dispensing means |
| 626 | receiving means |
| 740 | metal layer |
| 802, 804, 902 | coated area |
| 806 | uncoated area |

1-14. (canceled)

15. A method for the reduction treatment of a workpiece,
wherein an atmospheric plasma jet is generated,
wherein a workpiece to be reduced is brought into contact with a liquid,
wherein a surface of the workpiece to be reduced and/or the liquid is impinged with the atmospheric plasma jet,
wherein the workpiece is brought into contact with the liquid by arranging the workpiece in a volume of liquid by submerging it before the surface or the liquid is impinged with the plasma jet, and
wherein the impinging with the atmospheric plasma jet is accomplished in such a way that a portion of the liquid volume located above the workpiece is locally displaced by the atmospheric plasma jet.

16. The method according to claim 15,
wherein the portion of the liquid volume located above the workpiece is locally displaced by the atmospheric plasma jet practically completely, so that no liquid or only a thin liquid film with a height above the workpiece of less than 1 mm remains locally at the point of the plasma impact.

17. The method according to claim 15,
wherein the portion of the liquid volume located above the workpiece is locally displaced by the atmospheric plasma jet in such a way that a macroscopic liquid volume with a height of at least 1 mm remains above the workpiece surface at the point of plasma impact.

18. The method according to claim 15,
wherein the atmospheric plasma jet is generated using a reducing working gas, in particular a forming gas.

19. The method according to claim 15,
wherein a hydrogen-containing liquid, preferably a water-containing liquid, is used as the liquid.

20. The method according to claim 15,
wherein an organic liquid is used as the liquid.

21. The method according to claim 15,
wherein the atmospheric plasma jet is generated with a plasma nozzle and,
wherein the plasma nozzle has a nozzle opening from which the plasma jet emerges during operation.

22. The method according to claim 21,
wherein the plasma nozzle and the workpiece are moved relative to one another during the impinging with the plasma jet.

23. The method according to claim 15,
wherein the atmospheric plasma jet is generated by means of electrical discharges in a working gas.

24. The method according to claim 15,
wherein the atmospheric plasma jet is generated by means of an arc-like discharge in a working gas, and
wherein the arc-like discharge is generated by applying a high-frequency high voltage between electrodes.

25. The method according to claim 15,
wherein a precursor, in particular a metal-containing precursor, is added or has been added to the liquid, the precursor preferably being a salt.

26. The method according to claim 15,
wherein the workpiece is a strip-shaped workpiece, in particular a metal strip.

27. An apparatus for the treatment, in particular for cleaning, reduction treatment and/or coating, of a strip-shaped workpiece, in particular a metal strip, in particular for carrying out a method according to claim 26,
with an immersion bath device which is configured to guide a strip-shaped workpiece through an immersion bath and
with a plasma source for generating an atmospheric plasma jet,
wherein the plasma source is arranged and configured to impinge, during operation, the immersion bath or a strip-shaped workpiece guided through the immersion bath of the immersion bath device with an atmospheric plasma jet.
